(19) United States
(12) Patent Application Publication
(10) Pub. No.: US 2024/0073520 A1
(43) Pub. Date: Feb. 29, 2024

(54) DUAL CAMERA TRACKING SYSTEM

(71) Applicant: Sony Interactive Entertainment Inc., Tokyo (JP)

(72) Inventor: Frank Zhao, San Mateo, CA (US)

(21) Appl. No.: 17/823,058

(22) Filed: Aug. 29, 2022

(51) Int. Cl. H04N 5/232; A63F 13/213; A63F 13/26; H04N 5/225; H04N 13/25

(52) U.S. Cl. CPC H04N 5/232061; A63F 13/213; A63F 13/26; H04N 5/2252; H04N 5/2253; H04N 5/23212; H04N 5/23222; H04N 13/25

(57) ABSTRACT

A dual camera tracking system includes a main imager and an auxiliary imager the output of which is used to alter an aim and/or focus of the main imager. Both imagers may be mounted on a common housing. In embodiments, the common housing may be a head-mounted display (HMD) for a computer simulation such as a computer game.

### FIELD

The present application relates generally to dual camera tracking systems, and more particularly but not exclusively to dual camera tracking systems that may be used in standalone imaging systems and for head-mounted displays for extended reality (XR) applications such as computer games.

### BACKGROUND

As recognized herein, photographic applications of distant, small objects, such as bird-watching, can be enjoyed best with relatively large lenses and high-resolution cameras. As also recognized herein, such a lens has a narrow field of view, meaning that peripheral vision is lost when looking through the lens. Further, present principles recognize that the relatively large weight of such a lens coupled with a large aperture and narrow focus plane can complicate aiming the lens at the target subject, such as a flying bird. Even if the subject is within the frame, the photographer might not realize if the subject is in focus.

### SUMMARY

An auxiliary camera is integrated into a telephoto lens of a main or primary camera to provide subject tracking and situational awareness while viewing the viewfinder of the main camera. Stereoscopic depth data from the auxiliary camera can be used to establish the focal length of the lens of the main camera.

Accordingly, in one aspect an assembly includes at least one main camera configured to receive light through at least one lens and generate images based thereon. The assembly also includes at least one auxiliary camera configured to render a first auxiliary image, and at least one processor configured with instructions to, based at least in part on the first auxiliary image, establish a focal length of the lens. The instructions also are executable to, based at least in part on output of at least one machine learning (ML) model receiving at least the first image as input, control the main camera.

In examples, the auxiliary camera can include only a single lens and imager, or it can be a stereoscopic camera.

In non-limiting implementations the instructions may be executable to control the main camera at least in part by moving the lens of the main camera to capture a subject imaged by the auxiliary camera. In other implementations the instructions can be executable to control the main camera at least in part by presenting on at least one display an indication of where to aim the main camera.

In an example, the auxiliary camera is mounted to a hood of the lens. In a specific example the auxiliary camera is mounted to a front portion of the hood of the lens. The auxiliary camera can be supported by a housing with a surface matching and flush with a surface of the hood of the lens.

A computer simulation head-mounted display can support the main camera and the auxiliary camera.

In another aspect, a method includes imaging a subject using an auxiliary camera mounted on a lens assembly of a main camera, and establishing at least a focal length of a lens of the lens assembly at least in part based on the imaging.

In another aspect, an apparatus includes at least one main camera configured to receive light through at least one lens and generate images based thereon. At least one auxiliary camera is configured to render a first auxiliary image for controlling at least a focal length of the lens. Also, a housing includes a surface matching and flush with a surface of a hood of the lens and supporting the auxiliary camera.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIGS. 2 and 3 illustrate perspective views of an example embodiment in which an auxiliary camera such as a stereoscopic camera is mounted to a lens of a main imager to alter an aim and/or focus of the main camera;

FIG. 4 is a block diagram of an example camera assembly with an optional movable camera base shown in phantom;

FIG. 5 is a block diagram of an example camera assembly integrated into a computer simulation head-mounted display (HMD);

FIG. 6 illustrates another perspective view of a main camera with auxiliary camera coupled to a head-mounted apparatus configured to be worn on the head;

FIG. 7 illustrates a block diagram of an example architecture of hardware and/or software-implemented components;

FIG. 8 illustrates example logic in example flow chart format which may be executed by any one or more of the processors described herein;

\FIG. 9 illustrates an example screen shot of an example user interface consistent with present principles; and

FIG. 10 illustrates a screen shot of an example display in a computer simulation HMD.

### DETAILED DESCRIPTION

This disclosure relates generally to computer ecosystems including aspects of consumer electronics (CE) device networks such as but not limited to computer game networks and camera systems. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

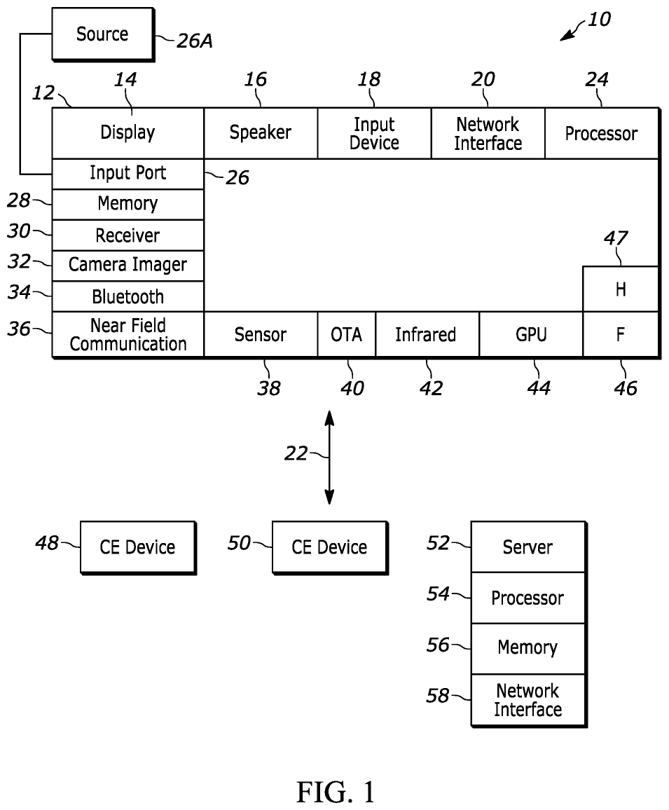

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24. The component 30 may also be implemented by an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

Continuing the description of the AVD 12, in some embodiments the AVD 12 may include one or more camera imagers 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. A camera imager may include, for example, a charge-coupled device (CCD) chip and/or complementary metal oxide semiconductor (CMOS) chip along with imaging components such as lenses, etc.

Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 (e.g., a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command)) that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content. Alternative or additional devices described herein such as a cameras may employ some or all of the components of the first CE device 48.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

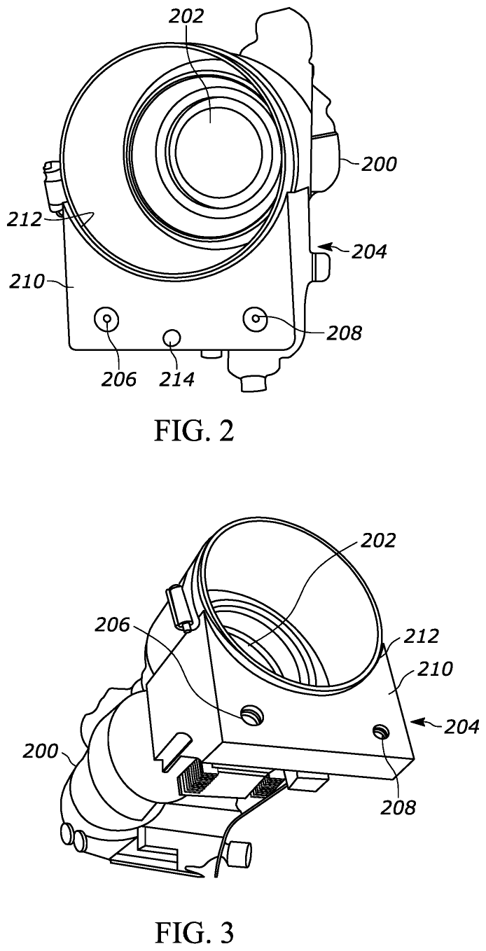

Referring now to FIGS. 2 and 3, a main or primary camera 200 such as but not limited to a Sony Alpha 1 or Alpha 6600 (which may be trademarked by Sony) can be coupled to a lens 202 such as a telephoto lens with, for example, a field of view of about 2.5°. Additionally, an auxiliary camera 204 may be provided as shown. In the example shown, the auxiliary camera 204 may be implemented by a stereoscopic camera with first and second lenses 206, 208 coupled to respective imagers, and may be supported in an auxiliary camera housing 210 configured, as shown, with a curved surface 212 to match the contour of the front part of the hood of the lens 202 with which the housing 210 is flushly engaged, e.g., by fasteners or adhesive. The housing 210 may be made by injection molding, 3D printing, or other appropriate technique. By placing the auxiliary camera on the front portion of the hood of the telephoto lens, as opposed to the main camera body, the relatively big telephoto lens will not obstruct the view of the auxiliary camera 204.

In some examples, a thermal imager 214 (FIG. 2) also may be provided on the auxiliary camera 204. The thermal imager may be used to detect a direction to a subject of interest for purposes of aligning the main camera to the direction.

The auxiliary camera 204 may have about an 85° field of view and can detect the distance to a photographic subject such as a bird using stereoscopic distance measurement techniques or other techniques.

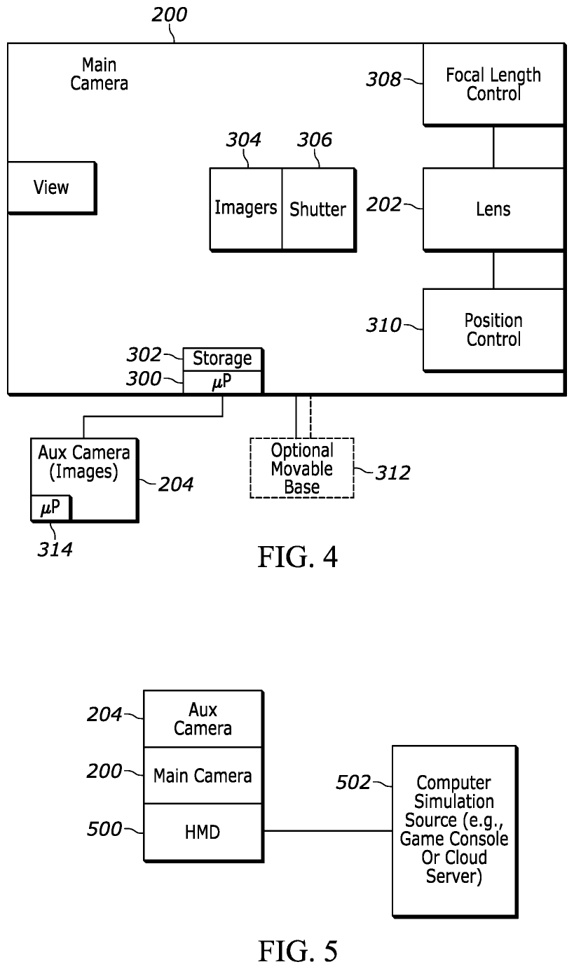

Turning now to FIG. 4, example non-limiting components of the assembly shown in FIGS. 2 and 3 are illustrated. The main camera 200 may include one or more processors 300 accessing one or more storages 302 and receiving images from the auxiliary camera 204 over, e.g., a universal serial bus (USB) link. The processor 300 may communicate with one or more imagers 304 that receives light from the lens 202 through, if desired, a shutter 306. The focal length of the lens 202 may be altered by a focal length controller 308 responsive to control signals from the processor 302. In some embodiments the lens 202 may be movable by a position controller 310 responsive to control signals from the processor 302. The position controller 310 may be implemented by, e.g., a motion stabilization device or other device coupled to the lens 202 (including coupled to the hood of the lens.) Or, the entire main camera 200 may be coupled to a movable base 312 to move the aim point of the camera responsive to control signals from the processor 302. It is to be understood that the auxiliary camera 204 may include components similar to those shown and described for the main camera. For example, the auxiliary camera 204 may include one or more processors 314 in addition to other components, for purposes to be shortly disclosed.

FIG. 5 illustrates another example implementation in which the auxiliary camera 204 and main camera 200 may be mounted on a head mounted display (HMD) 500 that can receive computer simulation signals such as computer game signals from a computer simulation source 502 such as a computer game console or computer game streaming server. Images from the cameras 202, 204 may be presented on the HMD 500 in addition to game images from the source 502.

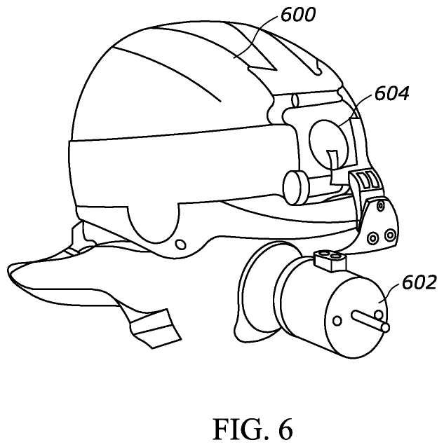

FIG. 6 illustrates a head-mounted apparatus 600 with a view finder 602 on which a main and auxiliary camera assembly 604 may be mounted.

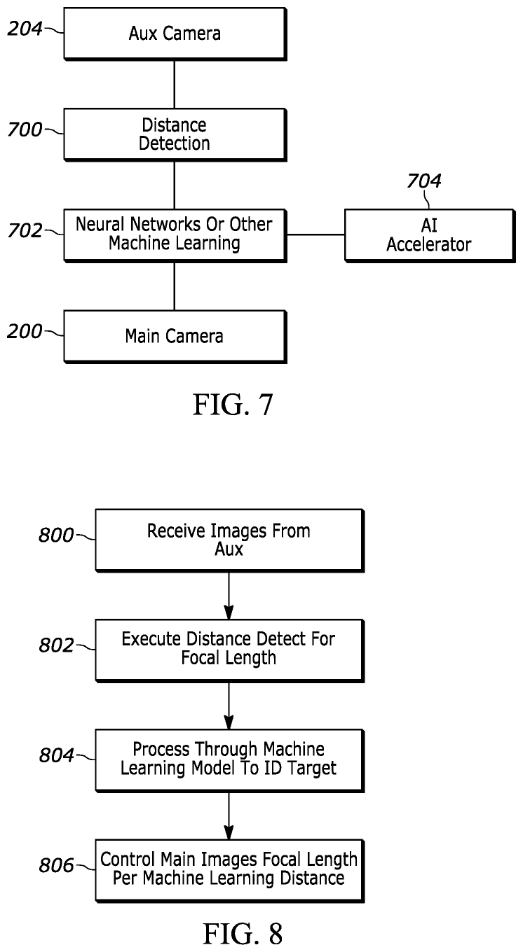

Now referring to FIG. 7 and returning to the discussion the assembly shown in FIGS. 2-4, one or more of the processors 300, 314 shown in FIG. 3 may execute a distance detection module 700 and one or more machine learning (ML) models 702 that may include one or more neural networks (NN) such as but not limited to a TensorFlow Lite NN for establishing the focal length and if desired aim point of the lens 202 shown in FIGS. 2-4. An artificial intelligence (AI) accelerator 704 also may be executed to speed processing.

The ML model 702 may be trained on a training set of images with various subjects in them and ground truth annotations of what the subjects are, for example.

In an example as illustrated in FIG. 8, at block 800 the executing processor(s) read images from the auxiliary camera 204. The distance to a subject of interest in the images is determined at block 802, and based on the distance the focal length of the lens 202 is established to place the subject in focus in the main camera 200. Also, block 804 indicates that the ML model 702 may be executed to recognize the subject of interest, which may be pre-defined to be, e.g., a bird or which may be defined by the user. It is to be understood that the execution of blocks 802 and 804 may not be in the order illustrated. At block 806 the focal length of the lens 202 of the main camera 200 and if desired its aim point may be adjusted to focus on the subject of interest as identified by the ML models 702.

In non-limiting examples, OpenCV image processing may be used for stereoscopic depth sensing. Execution of the ML model 702 may be accelerated by an Edge tensor processing unit (TPU) that can implemented the AI accelerator 704 in FIG. 7.

In one example implementation of FIG. 8, a full frame is obtained from the auxiliary camera 204. In an example, each frame may be 1280×400 pixels, and may be split into two 640×400 pixel images, left and right. The left frame can be run through the ML model 702 to detect the subject. Then, the bounding box of the detected subject (or object) can be is cropped and features extracted from the cropped box. A horizontal strip from the right-side image frame can then be cropped and from the strip, the same matching features from the cropped bounding box can be identified. The coordinates of matching features from the left and right sides can be average to locate the subject.

The depth may then be calculated by the distance detection modules 700 from the difference in X coordinates between the left-side features and right-side features. Cropping saves processing time and results in fewer otherwise useless features to detect. As used herein, features are “interesting” parts of an image, such as a distinctive edge or corner.

Note that focal length adjustment of the lens 202 may be in addition to autofocus and may provide a starting point for autofocus to begin.

If subject detection of the main camera 200 does not detect the desired subject, the auxiliary camera 204 may be queried for depth to the detected subject in the (wider view) auxiliary camera image. The focus distance of the lens 202 of the main camera 200 can then be established to a “close enough” starting point for autofocus search. If desired, the aperture may be temporarily narrowed to thicken the focus plane. The coordinates to the subject from the auxiliary camera 204 helps pick phase-detect autofocus points.

In another example, the auxiliary camera 204 may be implemented by a smart phone camera the images from which are provided to the main camera via Wi-Fi. The smartphone's view requires alignment, which can be automated via image feature matching between the smartphone's view and the main camera's view.

For multiple subjects of interest, ML may be used to detect and track multiple subjects so that on a single shutter button press, the camera autofocuses on one subject, takes a photo, automatically shifts the autofocus point to the next subject, automatically takes a second photo, and repeats for the other subjects detected.

In addition to techniques described above, focus stacking may be implemented to achieve deep depth of field but using a wide aperture. This provides better image quality for landscape photography for example and improved control of subject isolation in macro photography.

FIG. 9 illustrates a screen shot of the viewfinder of the main camera in which an indication 900 is presented of an out-of-view subject as detected by the auxiliary camera. In the example shown, the indication includes an arrow 902 indicating the direction the camera must be moved to image the subject and a text description 904 of the subject and its location. The arrow may be generated by comparing the pose of the main camera (orientation and position) as sensed by any of the sensors described in reference to FIG. 1 to the location of the out-of-view subject as reported by the auxiliary camera imaging the subject and comparing its position to the location of the auxiliary camera as sensed by any of the sensors described in FIG. 1, and determining the direction from the main camera to the subject.

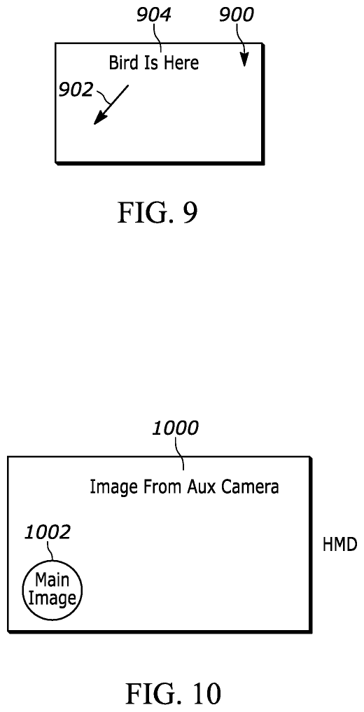

FIG. 10 illustrates a screen shot that may be presented on a HMD such as any HMD described herein, e.g., the HMD 500 shown in FIG. 5, in which an image 1000 from the auxiliary camera 204 (or from the computer game source) is presented on most of the display and a telescoped image 1002 of a subject from the main camera 200 also is presented. In either case, the auxiliary camera 204 may detect, for example a subject such as an animal in the real world near a person wearing a VR headset to cause the main camera 200 to focus on (and if desired move its line of sight) to the subject to image it. The image is presented on the HMD to alert the wearer that the subject is nearby.

Another example application is in an arena to focus on an interesting athlete or on an e-sports or physical sports spectator to present a magnified image from a main camera of the particular subject on a large screen stadium display.

While the particular embodiments are herein shown and described in detail, it is to be understood that the subject matter which is encompassed by the present invention is limited only by the claims.

What is claimed is:

1. An assembly, comprising:
at least one main camera configured to receive light through at least one lens and generate images based thereon;
at least one auxiliary camera configured to render a first auxiliary image; and
at least one processor configured with instructions to:
based at least in part on the first auxiliary image, establish a focal length of the lens; and
based at least in part on output of at least one machine learning (ML) model receiving at least the first image as input, control the main camera.

2. The assembly of claim 1, wherein the auxiliary camera comprises a single lens and imager.

3. The assembly of claim 1, wherein the auxiliary camera comprises a stereoscopic camera.

4. The assembly of claim 1, wherein the instructions are executable to:
control the main camera at least in part by moving the lens of the main camera to capture a subject imaged by the auxiliary camera.

5. The assembly of claim 1, wherein the instructions are executable to:
control the main camera at least in part by presenting on at least one display an indication of where to aim the main camera.

6. The assembly of claim 1, wherein the auxiliary camera is mounted to a hood of the lens.

7. The assembly of claim 6, wherein the auxiliary camera is mounted to a front portion of the hood of the lens.

8. The assembly of claim 6, wherein the auxiliary camera is supported by a housing comprising a surface matching and flush with a surface of the hood of the lens.

9. The assembly of claim 1, comprising a computer simulation head-mounted display supporting the main camera and the auxiliary camera.

10. A method, comprising:
imaging a subject using an auxiliary camera mounted on a lens assembly of a main camera; and
establishing at least a focal length of a lens of the lens assembly at least in part based on the imaging.

11. The method of claim 10, comprising:
controlling the main camera at least in part by moving the lens of the main camera to capture the subject imaged by the auxiliary camera.

12. The method of claim 10, comprising:
controlling the main camera at least in part by presenting on at least one display an indication of where to aim the main camera.

13. An apparatus comprising:
at least one main camera configured to receive light through at least one lens and generate images based thereon;
at least one auxiliary camera configured to render a first auxiliary image for controlling at least a focal length of the lens; and
a housing comprising a surface matching and flush with a surface of a hood of the lens and supporting the auxiliary camera.

14. The apparatus of claim 13, wherein the auxiliary camera comprises a single lens and imager.

15. The apparatus of claim 13, wherein the auxiliary camera comprises a stereoscopic camera.

16. The apparatus of claim 13, comprising:
at least one processor configured with instructions to:
based at least in part on the first auxiliary image, establish the focal length of the lens.

17. The apparatus of claim 16, wherein the instructions are executable to:
control the main camera at least in part by moving the lens of the main camera to capture a subject imaged by the auxiliary camera.

18. The apparatus of claim 16, wherein the instructions are executable to:
control the main camera at least in part by presenting on at least one display an indication of where to aim the main camera.

19. The apparatus of claim 13, wherein the auxiliary camera is mounted to a front portion of the hood of the lens.

20. The apparatus of claim 13, comprising a computer simulation head-mounted display supporting the main camera and the auxiliary camera.
